(19) United States
(12) Patent Application Publication
(10) Pub. No.: US 2026/0250539 A1
(43) Pub. Date: Aug. 27, 2026

(54) Recording Method, Treatment Liquid Ink Set, And Recording Apparatus

(71) Applicant: SEIKO EPSON CORPORATION, Tokyo (JP)

(72) Inventors: Kentaro HARA, Shiojiri (JP); Shun SUZUKI, Shiojiri (JP); Sena GOZU, Shiojiri (JP)

(21) Appl. No.: 19/550,686

(22) Filed: Feb. 26, 2026

(30) Foreign Application Priority Data
Feb. 27, 2025 (JP) 2025-030665

(51) Int. Cl. C09D 11/54; B41J 2/155; B41J 25/00; B41M 5/00; C09D 11/033; C09D 11/38; C09D 11/40; D21H 19/12; D21H 19/82

(52) U.S. Cl. CPC C09D 11/54; B41J 2/155; B41J 25/001; B41M 5/0017; C09D 11/033; C09D 11/38; C09D 11/40; D21H 19/12; D21H 19/828

(57) ABSTRACT

A recording method includes a treatment liquid adhering step of ejecting a treatment liquid containing an aggregating agent from an ink jet head to adhere the treatment liquid to a recording medium, and an ink adhering step of ejecting an ink composition which is an aqueous ink containing a coloring material from the ink jet head to adhere the ink composition to the recording medium, in which the recording medium is an absorptive recording medium, the treatment liquid contains a 1,2-alkanediol having a surface tension at 25° C. of 30 mN/m or less and an acetylene glycol-based surfactant having an HLB value of 5 or more, a content of the 1,2-alkanediol is 3% by mass or more with respect to a total amount of the treatment liquid, the aggregating agent contains a calcium salt, and a content of the calcium salt is 5% by mass or more with respect to the total amount of the treatment liquid.

The present application is based on, and claims priority from JP Application Serial Number 2025-030665, filed Feb. 27, 2025, the disclosure of which is hereby incorporated by reference herein in its entirety.

### BACKGROUND

### 1. Technical Field

The present disclosure relates to a recording method, a treatment liquid ink set, and a recording apparatus.

### 2. Related Art

A recording method using an ink jet method can record a high-quality image with a relatively simple apparatus, and thus various studies are conducted in various fields. In particular, in the light printing field using plain paper, a high color development property of the recorded material is required, and thus, improvement in the color development property is an issue attracting attention.

Regarding the improvement in the color development property, for example, a method of adhering a reaction solution to a recording medium to obtain a recorded material having high image quality is disclosed (for example, refer to JP-A-2016-068306).

However, in the case of an absorptive recording medium such as plain paper, the ink or the like adhered to the medium easily penetrates the medium, and there is a problem that the color development property of the recorded material is not yet sufficient as compared with other recording media.

Therefore, even when an absorptive recording medium is used, a recording method in which a recorded material exhibits a favorable color development is required.

### SUMMARY

According to an aspect of the present disclosure, there is provided a recording method including: a treatment liquid adhering step of ejecting a treatment liquid containing an aggregating agent from an ink jet head to adhere the treatment liquid to a recording medium; and an ink adhering step of ejecting an ink composition which is an aqueous ink containing a coloring material from the ink jet head to adhere the ink composition to the recording medium, in which the recording medium is an absorptive recording medium, the treatment liquid contains a 1,2-alkanediol having a surface tension at 25° C. of 30 mN/m or less and an acetylene glycol-based surfactant having an HLB value of 5 or more, a content of the 1,2-alkanediol is 3% by mass or more with respect to a total amount of the treatment liquid, the aggregating agent contains a calcium salt, and a content of the calcium salt is 5% by mass or more with respect to the total amount of the treatment liquid.

According to another aspect of the present disclosure, there is provided a treatment liquid ink set used in the recording method described above, the treatment liquid ink set including: the treatment liquid and the ink composition.

According to still another aspect of the present disclosure, there is provided a recording apparatus used in the recording method described above, the recording apparatus including: the treatment liquid; the ink composition; the ink jet head that performs the treatment liquid adhering step; and the ink jet head that performs the ink adhering step.

### BRIEF DESCRIPTION OF THE DRAWINGS

FIG. 1 is a schematic diagram showing an example of a recording apparatus according to an embodiment.

FIG. 2 is Table 1 illustrating the composition of an ink composition according to an example and a comparative example.

FIG. 3 is Table 2 illustrating the compositions and evaluation results of the treatment liquids according to the examples.

FIG. 4 is Table 3 illustrating the compositions and evaluation results of the treatment liquids according to examples and reference examples.

FIG. 5 is Table 4 illustrating the composition and evaluation results of the treatment liquids according to comparative examples.

### DESCRIPTION OF EMBODIMENTS

Hereinafter, embodiments of the present disclosure will be described. The embodiments described below describe examples of the present disclosure. The present disclosure is not limited to the following embodiments, and includes various modifications implemented within a range not changing a gist of the present disclosure. It should be noted that not all of the configurations described below are essential configurations of the present disclosure.

In the present specification, a numerical range indicated by using “to” means a range including numerical values described before and after “to” as a lower limit value and an upper limit value.

In the present specification, a material obtained by adhering an ink composition to a recording medium is referred to as a “recorded material” or a “printed material”.

In the present specification, the term “white” when referring to a “white pigment” or the like does not refer to only pure white, but also includes a color slightly colored with a chromatic color or an achromatic color or a color that has a glossy appearance as long as the color is within the range that can be visually recognized as white. For example, in CIELAB, L^{*} is preferably 80 or more, and more preferably L^{*} is 85 or more.

### 1. Recording Method

According to one embodiment of the present disclosure, there is provided a recording method including a treatment liquid adhering step of ejecting a treatment liquid containing an aggregating agent from an ink jet head to adhere the treatment liquid to a recording medium, and an ink adhering step of ejecting an ink composition which is an aqueous ink containing a coloring material from the ink jet head to adhere the ink composition to the recording medium, in which the recording medium is an absorptive recording medium, the treatment liquid contains a 1,2-alkanediol having a surface tension at 25° C. of 30 mN/m or less and an acetylene glycol-based surfactant having an HLB value of 5 or more, a content of the 1,2-alkanediol is 3% by mass or more with respect to a total amount of the treatment liquid, the aggregating agent contains a calcium salt, and a content of the calcium salt is 5% by mass or more with respect to the total amount of the treatment liquid.

In the related art, in printing using an ink jet method of ejecting an ink composition or the like from an ink jet head, improvement in a color development property of a printed material is required. However, in the case of printing on plain paper, which is an absorptive recording medium, when the ink adhered, the ink penetrated into the recording medium, and it was difficult to obtain better color development.

On the other hand, according to the recording method according to the present embodiment, by adhering the treatment liquid to the recording medium, it is possible to reduce the penetration of the ink composition adhered to the recording medium, and it is possible to improve the color development property of the recorded material.

Hereinafter, the steps included in the recording method according to the present embodiment and the recording medium used in the recording method according to the present embodiment will be described in detail.

### 1.1. Treatment Liquid Adhering Step

The recording method according to the present embodiment includes a treatment liquid adhering step of ejecting a treatment liquid containing an aggregating agent from an ink jet head to adhere the treatment liquid to a recording medium. The treatment liquid adhering step can be performed before the ink composition adhering step described later or at the same time as the ink composition adhering step. When the treatment liquid adhering step is performed before the ink composition adhering step, a treatment liquid composition is adhered to a predetermined region of the recording medium by a main scanning of the recording apparatus, and then the ink composition is adhered to the region by another main scanning. When the treatment liquid composition adhering step and the ink composition adhering step are performed at the same time, the treatment liquid and the ink composition are adhered to a predetermined region of the recording medium by the same main scanning of the recording apparatus.

Hereinafter, the treatment liquid used in the treatment liquid adhering step will be described.

### 1.1.2. Treatment Liquid

### 1.1.2.1. Aggregating Agent

The treatment liquid used in the recording method according to the present embodiment contains the aggregating agent. The aggregating agent contains a calcium salt. When the treatment liquid contains the aggregating agent, the treatment liquid reacts with the ink composition adhering to the recording medium to aggregate the components such as a coloring material, and thus the color development property of the recorded material is improved. In addition, by including the aggregating agent, the proportion of water in the reaction solution is reduced, and the recording medium is less likely to warp and the occurrence of curl is reduced during recording. Hereinafter, the curl generated during recording is referred to as a primary curl.

When the primary curl occurs, secondary curl, which will be described later, occurs in the process of drying the recording medium, and thus the occurrence of the secondary curl is also a concern.

When the treatment liquid is adhered to the recording medium in addition to the ink composition, the total amount of water adhering to the recording medium is increased, and the tendency of the curl to occur is increased. However, in the treatment liquid of the present embodiment, since the content of the calcium salt, which is an aggregating agent, in the treatment liquid is equal to or more than a predetermined value, the content of water in the treatment liquid is relatively low, and the curl is excellently suppressed.

In addition, the treatment liquid used in the recording method according to the present embodiment has the excellent color development property, and thus there is a tendency to reduce the need to excessively increase the amount of the treatment liquid adhering to the recording medium to enhance the color development property, and excellent curl suppression is obtained.

The calcium salt contained in the aggregating agent has a high solubility in water, that is, high water solubility, and thus can be contained in a large amount in the treatment liquid, and the reactivity between the treatment liquid and the ink composition can be improved. In addition, a polyvalent metal salt such as a calcium salt does not easily increase the viscosity even when contained in a large amount.

The calcium salt is preferably dissolved in an amount of 10 g or more with respect to 100 g of water at 20° C., more preferably 50 g or more, and even more preferably 100 g or more. When the water solubility of the calcium salt with respect to 100 g of water is in the above range, the reaction between the treatment liquid and the components in the ink composition is sufficiently performed, and the color development property of the recorded material is improved.

Examples of the calcium salt include an organic calcium salt and an inorganic calcium salt. Since the water solubility is higher and the reactivity with the ink composition is higher, the calcium salt is preferably an inorganic calcium salt. In a case where the water solubility of the calcium salt is high, even when the treatment liquid is dried in the nozzle of the head when the treatment liquid is ejected from the ink jet head, the calcium salt that is dissolved is less likely to precipitate. That is, the calcium salt is less likely to be foreign substances and less likely to hinder the ejection of the ink. In addition, when the water solubility of the calcium salt is high, the water solubility is high, so that the calcium salt is easily ionized in the reaction solution and a large amount of calcium ions are generated, and thus the reactivity with the ink composition is also high. In these points, an inorganic calcium salt is preferable. Examples of the inorganic calcium salt include calcium chloride, calcium nitrate, and the like.

The content of the calcium salt is 5% by mass or more, preferably 8% by mass or more, more preferably 9% by mass or more, and even more preferably 10% by mass or more, with respect to the total amount of the treatment liquid. Furthermore, 15% by mass or more is preferable, and 17% by mass or more is more preferable. When the content of the calcium salt is within the above range or more, the calcium salt is likely to contribute to the reaction with the ink composition, and the color development of the recorded material is improved, even in the recording medium in which the treatment liquid such as the absorptive recording medium is likely to penetrate. In addition, when the above-described range is exceeded, the curl suppression is more excellent, which is preferable.

The content of the calcium salt is preferably 25% by mass or less, more preferably 22% by mass or less, and even more preferably 20% by mass or less with respect to the total amount of the treatment liquid. When the content is within the above range, the calcium salt is easily dissolved sufficiently, and the ejection stability is more excellent.

### 1.1.2.2. Organic Solvent

### 1,2-Alkanediol

The treatment liquid used in the recording method according to the present embodiment contains an organic solvent, and the organic solvent contains 1,2-alkanediol. The 1,2-alkanediol contained in the treatment liquid contains 1,2-alkanediol having a surface tension at 25° C. of 30 mN/m or less. The surface tension at 25° C. described above refers to static surface tension.

When the treatment liquid contains 1,2-alkanediol having the surface tension at 25° C. of 30 mN/m or less, the droplets ejected by the ink jet method are easily separated. In addition, the trailing edge of the ejected droplet is also lengthened, and the coating area on the recording medium is widened. That is, the treatment liquid sufficiently covers the recording medium, and the portion to which the treatment liquid is not adhered is reduced. As described above, the ink composition to be adhered can be reduced in penetration, and the color development property of the recorded material can be improved by sufficiently covering the treatment liquid on the recording medium, that is, by improving the embedding of the treatment liquid in the recording medium.

In addition, the treatment liquid contains 1,2-alkanediol having the surface tension at 25° C. of 30 mN/m or less, so that the water solubility of the acetylene glycol-based surfactant described later is improved and it is less likely to be foreign substances at the time of nozzle ejection.

The surface tension of 1,2-alkanediol at 25° C. is 30 mN/m or less, preferably 29 mN/m or less, more preferably 28 mN/m or less, and even more preferably 27 mN/m or less. The surface tension of 1,2-alkanediol at 25° C. is preferably 10 mN/m or more, more preferably 15 mN/m or more, and even more preferably 20 mN/m or more. When the surface tension of 1,2-alkanediol at 25° C. is in the above range, the wetting and spreading property to the recording medium is improved, and the embedding of the treatment liquid is improved.

As a method for measuring the surface tension, a method of measuring the surface tension at a liquid temperature of 25° C. by the Wilhelmy method using a surface tension meter (for example, a surface tension meter CBVP-Z manufactured by Kyowa Interface Science Co., Ltd.) commonly used is used.

Hereinafter, unless otherwise specified, “1,2-alkanediol having the surface tension at 25° C. of 30 mN/m or less” is referred to as “1,2-alkanediol” or “specific 1,2-alkanediol”.

The number of carbon atoms in the specific 1,2-alkanediol is preferably 5 or more, and more preferably 5 or more to 7 or less. Examples of the specific 1,2-alkanediol include 1,2-pentanediol, 1,2-hexanediol, 1,2-heptanediol, and the like. Among these, 1,2-hexanediol is particularly preferable.

The content of the specific 1,2-alkanediol is 3% by mass or more, preferably 4% by mass or more, and more preferably 5% by mass or more with respect to the total amount of the treatment liquid. When the content of the specific 1,2-alkanediol is in the above range, the embedding of the treatment liquid in the recording medium is improved. In addition, when the content of the specific 1,2-alkanediol is too high, the dynamic surface tension of the treatment liquid decreases, and the trailing edge and scattering when the treatment liquid is ejected increases. Therefore, the content of the specific 1,2-alkanediol is preferably 15% by mass or less, more preferably 10% by mass or less, and even more preferably 8% by mass or less with respect to the total amount of the treatment liquid.

### Other Organic Solvents

The treatment liquid may contain an organic solvent other than the specific 1,2-alkanediol. Examples of such an organic solvent include esters, alkylene glycol ethers, cyclic esters, amides, alcohols, and polyhydric alcohols other than the specific 1,2-alkanediols.

Examples of the esters include glycol monoacetates and glycol diesters.

The alkylene glycol ethers may be alkylene glycol monoethers or diethers, and are preferably alkyl ethers. Specific examples thereof include alkylene glycol monoalkyl ethers such as ethylene glycol monomethyl ether, diethylene glycol monomethyl ether, triethylene glycol monobutyl ether, and tetraethylene glycol monomethyl ether; and alkylene glycol dialkyl ethers such as ethylene glycol dimethyl ether, diethylene glycol dibutyl ether, triethylene glycol diethyl ether, and tripropylene glycol dimethyl ether.

Examples of cyclic esters include cyclic esters (lactones) such as β-propiolactone, γ-butyrolactone, δ-valerolactone, and ε-caprolactone, and compounds in which the hydrogen of the methylene group adjacent to the carbonyl group is substituted with an alkyl group having 1 to 4 carbon atoms.

Examples of the amides include cyclic amides, acyclic amides, and the like. Examples of the acyclic amides include alkoxyalkylamides.

Examples of the cyclic amides include lactams. Examples of the lactams include pyrrolidones such as 2-pyrrolidone, 1-methyl-2-pyrrolidone, 1-ethyl-2-pyrrolidone, 1-propyl-2-pyrrolidone, and 1-butyl-2-pyrrolidone.

Examples of the alkoxyalkylamides include 3-methoxy-N, N-dimethylpropionamide, 3-methoxy-N, N-diethylpropionamide, 3-methoxy-N, N-methylethylpropionamide, and the like.

Examples of alcohols include a compound in which one hydrogen atom of alkane is substituted with a hydroxyl group. The alkane preferably has 10 or less carbon atoms, more preferably 6 or less carbon atoms, and even more preferably 3 or less carbon atoms. The number of carbon atoms of the alkane is 1 or more, and is preferably 2 or more. The alkane may be a linear type or a branched type.

Examples of alcohols include methanol, ethanol, n-propanol, iso-propanol, n-butanol, 2-butanol, tert-butanol, iso-butanol, n-pentanol, 2-pentanol, 3-pentanol, and tert-pentanol, 2-phenoxyethanol, benzyl alcohol, phenoxypropanol, and the like.

Polyhydric alcohols have two or more hydroxyl groups in the molecule. Examples of the polyhydric alcohols include alkanediols and other polyhydric alcohols.

Examples of alkanediols include compounds in which alkane is substituted with two hydroxyl groups. Examples of alkanediols include 1,2-alkanediol, which is a general term for compounds in which hydroxyl groups are substituted at the first and second positions of alkanes, and other alkanediols other than 1,2-alkanediol. Among these, the specific 1,2-alkanediol is as described above, and thus is omitted.

Examples of alkanediols other than specific 1,2-alkanediol include 1,3-propanediol, 1,3-butyleneglycol (also known as 1,3-butanediol), 1,4-butanediol, 2,3-butanediol, 1,5-pentanediol, 1,2-butanediol, propylene glycol, and the like.

Examples of other polyhydric alcohols include a condensate in which two or more molecules of alkanediols are intermolecularly condensed with each other via the hydroxyl group thereof, a compound having three or more hydroxyl groups, and the like.

Examples of the condensate in which two or more molecules of alkanediols are intermolecularly condensed between hydroxyl groups include dialkylene glycol such as diethylene glycol and dipropylene glycol, trialkylene glycol such as triethylene glycol and tripropylene glycol, and the like.

The compound having three or more hydroxyl groups is a compound having three or more hydroxyl groups having an alkane or polyether structure as a skeleton. Examples of the compound having three or more hydroxyl groups include glycerin, trimethylolethane, trimethylolpropane, 1,2,5-hexanetriol, 1,2,6-hexanetriol, pentaerythritol, polyoxypropylenetriol, and the like.

The total content of the organic solvent including the specific 1,2-alkanediol is preferably 3% to 30% by mass, more preferably 6% to 25% by mass, and even more preferably 8% to 20% by mass with respect to the total amount of the treatment liquid. In this case, the embedding, the curl suppression, the ejection stability, and the like are more excellent, which is preferable.

### 1.1.2.3. Acetylene Glycol-Based Surfactant

The treatment liquid used in the recording method according to the present embodiment contains an acetylene glycol-based surfactant having an HLB value of 5 or more.

The treatment liquid contains the acetylene glycol-based surfactant having an HLB value of 5 or more, so that the wetting and spreading property of the treatment liquid on the recording medium is improved, the embedding of the treatment liquid in the recording medium is favorable, and the color development property is excellent. In addition, when the treatment liquid is ejected from the nozzle, it is easily formed into droplets, resulting in favorable ejection stability.

In addition, when the HLB value of the acetylene glycol-based surfactant is 5 or more, the wetting and spreading property of the treatment liquid and the dropletization are improved, the treatment liquid has too high permeability into the absorptive recording medium, which reduces the risk of the treatment liquid penetrating into the absorptive recording medium and inhibiting the reaction with the ink, and the color development property of the ink composition is excellent.

In addition, when the HLB value of the acetylene glycol-based surfactant is 5 or more, the water solubility is high, so that it is difficult to separate the phase in the treatment liquid and it is less likely to be foreign substances when the treatment liquid is ejected.

The acetylene glycol-based surfactant tends to have less foaming than other surfactants such as silicone-based surfactants. Therefore, when the treatment liquid fills the cartridge of the ink jet printer, the generation of air bubbles is small. That is, the initial filling property to the cartridge is favorable.

In addition, acetylene glycol-based surfactants having an HLB value of less than 5 have too high permeability to the absorptive recording medium for the treatment liquid, and the treatment liquid penetrates into the absorptive recording medium, so that the reaction with the ink composition is inhibited and the color development property of the ink composition is inferior.

Here, the HLB value is a value determined from the balance between the hydrophilic group and the lipophilic group of the surfactant molecule. A high HLB value qualitatively indicates that the surfactant has high hydrophilicity, and a low HLB value qualitatively indicates that the surfactant has high lipophilicity.

The HLB value in the present specification is defined as follows. The “hydrophilic lipophilic balance (HLB) value” is calculated by the Griffin method. Specifically, the HLB value of the surfactant can be calculated according to the following equation (H).

HLB value=20×(% by mass of hydrophilic group) (H)

The HLB value of the acetylene glycol-based surfactant is preferably 6 or more, more preferably 7 or more, even more preferably 10 or more, even more preferably 12 or more, and particularly preferably 13 or more. When the HLB value is equal to or more than the above range, the color development property, water solubility, and the like are more excellent.

In addition, the HLB value of the acetylene glycol-based surfactant is preferably 20 or less, more preferably 18 or less, and even more preferably 15 or less. Furthermore, 10 or less is preferable, and 9 or less is preferable. When the above range is satisfied, the embedding, the ejection stability, and the like are more excellent.

The acetylene glycol-based surfactant having an HLB value of 5 or more may be used in one or more types.

The acetylene glycol-based surfactant may contain an acetylene glycol-based surfactant having an HLB value of 10 or more (hereinafter, also referred to as a “high HLB value”) and an acetylene glycol-based surfactant having an HLB value of 5 or more and less than 10 (hereinafter, also referred to as a “low HLB value”). By using the acetylene glycol-based surfactant having the high HLB value and the acetylene glycol-based surfactant having the low HLB value in combination, the wetting and spreading property of the treatment liquid becomes more suitable, and the color development of the ink composition to be adhered becomes more favorable.

The acetylene glycol-based surfactant having the low HLB value preferably has an HLB value of 5 or more and less than 10, and more preferably has an HLB value of 6 or more and less than 9. When the HLB value is in the above range, the wetting and spreading property of the treatment liquid is further improved.

The acetylene glycol-based surfactant having the high HLB value preferably has an HLB value of 10 or more, and more preferably has an HLB value of 12 or more. In addition, the acetylene glycol-based surfactant having the high HLB value is not particularly limited, but the HLB value is preferably 20 or less, and more preferably 18 or less.

Examples of commercially available acetylene glycol-based surfactants include Orfin EXP4300, Orfin E1004 (HLB value 7 to 9), Surfynol SE (HLB value 6), Surfynol 440 (HLB value 8), Orfin E1010 (HLB value 13 to 14), Orfin E1020 (HLB value 15 to 16), Orfin E 1030W (HLB value 15 to 16), and Surfynol 485 (HLB value 17) (all of the above are trade names, manufactured by Nisshin Chemical Industry Co., Ltd.).

The total content of the acetylene glycol-based surfactant is preferably 0.05% by mass or more and 2.0% by mass or less, more preferably 0.1% by mass or more and 1.8% by mass or less, and even more preferably 0.2% by mass or more and 1.5% by mass or less, with respect to the total amount of the treatment liquid. Furthermore, 0.5% to 1.4% by mass is preferable, 0.8% to 1.4% by mass is preferable, and 1.0% to 1.4% by mass is preferable.

The content of the high HLB acetylene glycol-based surfactant is preferably 0.05% to 2.0% by mass, more preferably 0.2% to 1.8% by mass, even more preferably 0.4% to 1.5% by mass, still more preferably 0.5% to 1.3% by mass, and even more preferably 0.7% to 1.2% by mass, with respect to the total amount of the treatment liquid.

The content of the low HLB acetylene glycol-based surfactant is preferably 0.05% to 2.0% by mass, more preferably 0.1% to 0.8% by mass, even more preferably 0.2% to 0.6% by mass or less, and even more preferably 0.3% to 0.5% by mass, with respect to the total amount of the treatment liquid.

When the content of the acetylene glycol-based surfactant is in the above range, the embedding of the treatment liquid in the recorded material and the ejection stability of the treatment liquid are improved.

The mass ratio (w1/w2) of the content (w1) of the acetylene glycol-based surfactant having the low HLB value to the total content (w2) of the acetylene glycol-based surfactant is preferably 0.05 or more and 0.6 or less, more preferably 0.1 or more and 0.5 or less, and even more preferably 0.2 or more and 0.4 or less. When the mass ratio of the acetylene glycol-based surfactant is in the above range, the ejection stability during recording is further improved.

The acetylene glycol-based surfactant contained in the treatment liquid may or may not further contain an acetylene glycol-based surfactant having an HLB value of less than 5, but the content thereof is preferably small in terms of the color development property and water solubility, and is preferably not more than 0.4% by mass, more preferably not more than 0.2% by mass, further more preferably not more than 0.1% by mass, and still further more preferably not more than 0.05% by mass, with respect to the total amount of the treatment liquid. The lower limit of the content is 0% by mass.

### 1.1.2.4. Moisturizer

The treatment liquid used in the recording method according to the present embodiment preferably contains a moisturizer.

Examples of the moisturizer include liquid moisturizers such as glycerin and solid moisturizers such as betaine. As the liquid moisturizer, those having particularly high moisturizing properties among the above-described organic solvents can be used, and these are also organic solvents.

Examples of the moisturizer include betaine, glycerin, and the like.

### Betaine

The treatment liquid preferably contains betaine. The betaine is a compound in which a charge and a negative charge are present at positions not adjacent to each other in the same molecule, hydrogen that can dissociate is not bonded to an atom having a positive charge to form an intramolecular salt, and a molecule as a whole does not have a charge. In the present embodiment, it is preferable that the betaine has a positive charge site as a quaternary ammonium cation.

By containing betaine in the treatment liquid, the curl generated in the recorded material can be reduced. In particular, the curl (hereinafter, also referred to as “secondary curl”) generated by drying of the ink composition or the like after recording and floating of the end portion of the recording medium from the ground surface is reduced.

In addition, since the treatment liquid contains betaine, there is an effect of reducing phase separation of the acetylene glycol-based surfactant and suppressing the occurrence of foreign substances.

The betaine is not particularly limited, and examples thereof include trialkylglycine such as trimethylglycine and triethylglycine, γ-butyrobetaine, homarine, trigonelline, carnitine, homoserine betaine, valine betaine, lysine betaine, ornithine betaine, alanine betaine, stachydrine, and glutamic acid betaine. Among them, as the glycine contained in the treatment liquid, it is preferable to be selected from trialkylglycine, and it is preferable that all the alkyl groups are trialkylglycine having 3 or less carbon atoms, and it is more preferable to contain trimethylglycine. The trialkylglycine is a compound in which three alkyl groups are substituted for the nitrogen atom of glycine. As a result, the clogging recovery property tends to be further improved. The betaine may be used alone or in combination of two or more.

The number of carbon atoms constituting the betaine is preferably 4 to 12, more preferably 4 to 7, and even more preferably 4 to 6. When the number of carbon atoms constituting the betaine is in the above range, the stability of the treatment liquid is further improved.

The content of the betaine is preferably 0.5% by mass or more and 20% by mass or less, more preferably 1% by mass or more and 15% by mass or less, even more preferably 2% by mass or more and 10% by mass or less, still more preferably 3% by mass or more and 9% by mass or less, and particularly preferably 4% by mass or more and 7% by mass or less, with respect to the total amount of the treatment liquid. When the content of betaine is in the above range, the ejection stability of the treatment liquid is improved, and the occurrence of secondary curl of the recorded material can be reduced.

### Glycerin

The treatment liquid may contain glycerin as the moisturizer. Since the treatment liquid contains glycerin, the treatment liquid is less likely to dry, and the ejection stability during recording is improved. In addition, the water solubility of the acetylene glycol-based surfactant can be further improved.

When glycerin is excessively contained, the primary curl of the recorded material is likely to occur. Therefore, the content of glycerin is preferably 0.1% by mass or more and 9% by mass or less, more preferably 0.5% by mass or more and 7% by mass or less, and even more preferably 1% by mass or more and 5% by mass or less, with respect to the total amount of the treatment liquid. When the content of glycerin is in the above range, the occurrence of primary curls is reduced.

In addition, glycerin is a polyhydric alcohol having a standard boiling point of more than 280° C., and the content of polyhydric alcohols having a standard boiling point of more than 280° C., which is not limited to glycerin, may also be set within the above range, and this is preferable in the above points.

### Others

The treatment liquid may contain other moisturizers other than the above-described moisturizer. The other moisturizers are not particularly limited, and examples thereof include urea and the like. Specific examples of the ureas include urea, ethylene urea, tetramethylurea, thiourea, 1,3-dimethyl-2-imidazolidinone, or the like.

### 1.1.2.5. Water

The treatment liquid used in the recording method according to the present embodiment may contain water. Examples of the water include pure water such as ion-exchanged water, ultrafiltration water, reverse osmosis water, and distilled water, water having reduced ionic impurities such as ultrapure water, and the like. Furthermore, when water sterilized by irradiation with ultraviolet rays, addition of hydrogen peroxide, or the like is used, generation of bacteria and fungi can be suppressed when the ink composition is stored for a long period of time.

The content of water is preferably 30% by mass or more, more preferably 40% by mass or more, even more preferably 45% by mass or more, and particularly preferably 50% by mass or more, with respect to the total amount of the treatment liquid. In addition, the content of water is preferably 99% by mass or less, more preferably 90% by mass or less, and even more preferably 80% by mass or less. Furthermore, 75% by mass or less is preferable, and 70% by mass or less is more preferable. When the above range is satisfied, it is preferable in terms of curl suppression.

### 1.1.2.6. Other Components

The treatment liquid used in the recording method according to the present embodiment may further contain components such as a preservative/antifungal agent, a rust preventive, a chelating agent, a viscosity modifier, and an antioxidant, as necessary.

### 1.2. Ink Composition Adhering Step

The recording method according to the present embodiment includes an ink adhering step of ejecting an ink composition, which is an aqueous ink containing a coloring material, from an ink jet head to adhere the ink composition to the recording medium. The ink composition adhering step can be performed after the above-described treatment liquid adhering step or at the same time as the treatment liquid adhering step.

Hereinafter, the ink composition used in the ink composition adhering step will be described.

### 1.2.1. Ink Composition

### 1.2.1.1. Coloring Material

The ink composition used in the recording method according to the present embodiment contains a coloring material. The coloring material is not particularly limited, and examples thereof include a dye or a pigment. Among these, it is preferable to use a pigment because the pigment has a property of being less likely to fade even with respect to light, gas, and the like. The recorded material recorded with the ink using the pigment has favorable water resistance, gas resistance, light resistance, and storage stability.

The content of the coloring material is preferably 0.5% by mass or more, more preferably 1.0% by mass or more and 14% by mass or less, even more preferably 2.0% by mass or more and 12% by mass or less, still more preferably 4.0% by mass or more and 10% by mass or less, and particularly preferably 6% by mass or more and 8% by mass or less, with respect to the total amount of the ink composition.

When the content of the coloring material is in the above range, the color development of the ink composition is favorable, and the storage stability is also favorable.

### Pigment

As the pigment, either an inorganic pigment or an organic pigment can be used. Examples of the inorganic pigment include carbon black; a compound such as a metal oxide, a metal sulfide, or a metal chloride; and inorganic particles such as kaolin, talc, and calcium carbonate.

Examples of the organic pigment include azo pigments such as insoluble azo pigments, condensed azo pigments, azo lakes, and chelate azo pigments, polycyclic pigments such as phthalocyanine pigments, perylene and perinone pigments, anthraquinone pigments, quinacridone pigments, dioxane pigments, thioindigo pigments, isoindolinone pigments, and quinophthalone pigments, dye chelates, dye lakes, nitro pigments, nitroso pigments, aniline black, and daylight fluorescent pigments. These pigments may be used alone or in combination of two or more thereof.

The pigment may be a self-dispersed pigment or a resin-dispersed pigment. The self-dispersed pigment is a pigment that can be dispersed and/or dissolved in an aqueous medium without a dispersant such as a resin or a surfactant. Here, the term “dispersion and/or dissolution in the aqueous medium without a dispersant” refers to a state in which the pigment is stably present in the aqueous medium by the hydrophilic group on the surface thereof without using a dispersant for dispersing the pigment.

Examples of the self-dispersed pigment include pigments in which a hydrophilic group is directly or via another atomic group bonded to the pigment surface, for example, a pigment in which a functional group containing an anionic group is bonded to the surfaces of the pigment particles, or a pigment in which an anionic resin is chemically bonded to the surfaces of the pigment particles.

Examples of the hydrophilic group on the surface of the self-dispersed pigment include a group in which a part of the hydrogen atoms of —OM, —COOM, —CO—, —SO₃M, —SO₂M, —SO₂NH₂, —RSO₂M, —PO₃HM, —PO₃M₂, —SO₂NHCOR, —NH₃, and —NR₃ and the propyleneoxy chain is substituted with M. M in the formula represents a hydrogen atom, an alkali metal, an ammonium, or an organic amine, and R represents a naphthyl group having an alkyl group or a substituent having carbon atoms of 1 or more and 12 or less.

In addition, examples of other atomic groups include linear or branched alkylene groups having carbon atoms of 1 or more and 12 or less, phenylene groups, naphthylene groups, amide groups, sulfonyl groups, amino groups, carbonyl groups, ester groups, ether groups, groups combining these groups, and the like.

The resin-dispersed pigment is a pigment dispersed with a resin. The resin used for dispersing the pigment is also referred to as a resin dispersant.

Examples of resin dispersants used for the resin-dispersed pigment include polyvinyl alcohols, polyacrylic acid, acrylic acid-acrylonitrile copolymers, vinyl acetate-acrylate ester copolymers, acrylic acid-acrylic acid ester copolymers, styrene-acrylic acid copolymers, styrene-methacrylic acid copolymers, styrene-methacrylic acid-acrylic acid ester copolymers, styrene-α-methyl styrene-acrylic acid copolymers, styrene-α-methyl styrene-acrylic acid-acrylic acid ester copolymers, styrene-maleic acid copolymers, styrene-maleic anhydride copolymers, vinyl naphthalene-acrylic acid copolymers, vinyl naphthalene-maleic acid copolymers, vinyl acetate-maleic acid ester copolymers, vinyl acetate-crotonic acid copolymers, vinyl acetate-acrylic acid copolymers, and the like and salts thereof. Among these, a copolymer of a monomer having a hydrophobic functional group and a monomer having a hydrophilic functional group, and a polymer formed of monomers having both a hydrophobic functional group and a hydrophilic functional group are preferable. As the form of the copolymer, any form of a random copolymer, a block copolymer, an alternating copolymer, and a graft copolymer can be used. Regarding the resin dispersant, one kind thereof may be used alone, or two or more kinds thereof may be used in combination.

The pigment preferably contains one or more of a self-dispersed pigment and a resin-dispersed pigment, and more preferably contains a self-dispersed pigment.

### Dye

The dyes are not particularly limited, and acid dyes, direct dyes, reactive dyes, and basic dyes can be used. Examples of the dye include C.I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C.I. Food Black 1 and 2, C.I. Direct Yellow 1, 12, 24, 33, 50, 55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35.

Regarding the dye, one kind thereof may be used alone, or two or more kinds thereof may be used in combination.

### 1.2.1.2. Resin

The ink composition used in the recording method according to the present embodiment may contain a resin. Since the ink composition contains a resin, the adhesion of the ink component adhered to the recording medium is improved, and the transfer to other recorded materials or the like is reduced when the recorded materials are overlapped. That is, the contained resin acts as a fixing resin. As the resin, a water-soluble resin or an emulsion of resin particles can be used.

The water-soluble resin is not particularly limited, and examples thereof include a urethane resin, an acrylic resin, a polyalkylene oxide resin, a polyvinyl alcohol resin, a carboxymethyl cellulose resin, and the like. As the water-soluble resin, a urethane resin or an acrylic resin is preferable.

The resin particles may have a powdery property, but it is preferable that the resin particles are in an emulsion form from the viewpoint of ejection stability during recording.

The resin particles are not particularly limited, and examples thereof include water-dispersible resins formed of urethane-based resins, acrylic resins containing styrene-acrylic resins, fluorene-based resins, olefin-based resins, rosin-modified resins, terpene-based resins, ester-based resins, amide-based resins, epoxy-based resins, vinyl chloride-based resins, vinyl chloride-vinyl acetate copolymers, ethylene vinyl acetate-based resins, and the like. Among these, as the resin particles, acrylic resin and urethane-based resin are more preferable. The resin may be used alone or in combination of two or more.

The urethane-based resin is a general term for a resin having a urethane bond. For the urethane-based resin, a polyether-type urethane resin including an ether bond in the main chain, a polyester-type urethane resin including an ester bond in the main chain, and a polycarbonate-type urethane resin including a carbonate bond in the main chain, in addition to a urethane bond, and the like can be used. As the resin particles of the urethane-based resin, commercially available products may be used, for example, the urethane-based resin selected from the commercially available products such as Superflex 460, 460s, 840, E-4000 (trade name, manufactured by DKS Co., Ltd.), Resamine D-1060, D-2020, D-4080, D-4200, D-6300, D-6455 (trade name, manufactured by Dainichiseika Color & Chemicals MFG Co., Ltd.), Takelac WS-6021, W-512-A-6 (trade name, manufactured by Mitsui Chemicals Polyurethane Co., Ltd.), Sancure 2710 (trade name, manufactured by LUBRIZOL), Permarin UA-150 (trade name, manufactured by Sanyo Chemical Industries Ltd.), and the like may be used.

An acrylic resin is a general term for polymers obtained by polymerizing at least an acrylic monomer such as (meth)acrylic acid and (meth)acrylic acid ester as one component, and examples thereof include a resin obtained from an acrylic monomer, a copolymer of an acrylic monomer and a monomer other than acrylic monomer, and the like. Examples thereof include an acrylic-vinyl-based resin which is a copolymer of an acrylic monomer and a vinyl-based monomer and the like. In addition, examples thereof include a copolymer with a vinyl-based monomer such as styrene.

As the acrylic monomer, acrylamide, acrylonitrile, and the like can also be used. Examples of commercially available water-dispersible resins using an acrylic resin as a raw material include FK-854 (trade name, manufactured by Chuo Kagaku Kogyo Co., Ltd.), Movinyl 952B and 718A (trade name, manufactured by Nippon Synthetic Chemical Industry Co., Ltd.), Nipol LX852 and LX874 (trade name, manufactured by Zeon Corporation), and the like.

The styrene-acrylic resin is a copolymer obtained from a styrene monomer and an acrylic monomer, and examples thereof include a styrene-acrylic acid copolymer, a styrene-methacrylic acid copolymer, a styrene-methacrylic acid-acrylic acid ester copolymer, a styrene-α-methylstyrene-acrylic acid copolymer, a styrene-α-methylstyrene-acrylic acid-acrylic acid ester copolymer, and the like. As the resin of the styrene-acrylic resin, a commercially available product may be used, for example, Joncryl 62J, 7100, 390, 711, 511, 7001, 632, 741, 450, 840, 74J, HRC-1645J, 734, 852, 7600, 775, 537J, 1535, PDX- 7630A, 352J, 352D, PDX- 7145, 538J, 7640, 7641, 631, 790, 780, 7610 (trade name, manufactured by BASF Japan Ltd.), Movinyl 966A, 975N (trade name, manufactured by Nippon Synthetic Chemical Industry Co., Ltd.), Vinyblan 2586 (manufactured by Nisshin Chemical Industry Co., Ltd.), and the like may be used.

A glass transition temperature (Tg) of the resin particles is preferably −50° C. or more and 70° C. or less, more preferably −10° C. or more and 50° C. or less, and even more preferably 0° C. or more and 40° C. or less. When the glass transition temperature of the resin particles is in the above range, the ejection stability at the time of recording is improved.

The glass transition temperature (Tg) of the resin can be confirmed by a method using differential scanning calorimetry (DSC) or the like.

The content of the resin is preferably 0.1% by mass or more and 5% by mass or less, more preferably 0.2% by mass or more and 3% by mass or less, and even more preferably 0.2% by mass or more and 2% by mass or less, with respect to the total amount of the ink composition. Furthermore, 0.3 to 1% by mass is preferable, and 0.4 to 0.8% by mass is more preferable.

### 1.2.1.3. Organic Solvent

The ink composition used in the recording method according to the present embodiment may contain an organic solvent. The organic solvent is preferably water-soluble. Examples of the function of the organic solvent include improving the wetting and spreading property of the ink composition with respect to the recording medium and enhancing the moisturizing property of the ink composition.

The organic solvent is not particularly limited, and is as described in the section of “1.1.2.2. Organic Solvent”. Examples thereof include those described in the section of “1.1.2.2. Organic solvent”, and among them, those containing polyhydric alcohols are preferable, and those containing alkanediols or polyhydric alcohols having a standard boiling point of more than 280° C. are more preferable.

By containing the polyhydric alcohols having a standard boiling point of more than 280° C., the moisturizing property of the ink composition is improved, and the ejection stability of the ink composition at the time of recording can be made favorable. In addition, when the ink composition contains an acetylene glycol-based surfactant as the surfactant described later, the water solubility of the acetylene glycol-based surfactant is improved, and an effect of reducing the occurrence of phase separation is obtained.

Examples of polyhydric alcohols having a standard boiling point of more than 280° C. include glycerin, triethylene glycol, tetraethylene glycol, and the like. Examples of polyols having a standard boiling point of 280° C. or less include ethylene glycol, diethylene glycol, pentaethylene glycol, propylene glycol, dipropylene glycol, tripropylene glycol, 1,3-propanediol, 1,2-butanediol, 1,2-pentanediol, 1,2-hexanediol, 1,4-butanediol, 1,5-pentanediol, 1,6-hexanediol, and the like.

The content of the polyhydric alcohols having a standard boiling point of more than 280° C. is preferably 0.1% by mass or more and 25% by mass or less, more preferably 0.5% by mass or more and 23% by mass or less, even more preferably 1.0% by mass or more and 20% by mass or less, and particularly preferably 5.0% by mass or more and 15% by mass or less, with respect to the total amount of the ink composition. When the content of the polyol having a standard boiling point of more than 280° C. is in the above range, the ejection stability of the ink composition is improved. In addition, when the ink composition contains an acetylene glycol-based surfactant, the water solubility of the acetylene glycol-based surfactant is improved.

### 1.2.1.4. Moisturizer

The ink composition used in the recording method according to the present embodiment may contain a moisturizer. The moisturizer is as described in the section of “1.1.2.4. Moisturizer”.

The ink composition preferably contains betaine as a moisturizer. By containing betaine in the ink composition, the ejection stability of the ink composition is improved.

The content of betaine is preferably 1.0% by mass or more and 15.0% by mass or less, more preferably 3.0% by mass or more and 13.0% by mass or less, even more preferably 5.0% by mass or more and 10.0% by mass or less, and still more preferably 6.0% by mass or more and 9.0% by mass or less, with respect to the total amount of the ink composition.

In addition, the ink composition preferably contains glycerin as a moisturizer. By containing glycerin in the ink composition, the ejection stability of the ink composition is improved.

The content of the glycerin is preferably 1.0% by mass or more and 15.0% by mass or less, more preferably 2.0% by mass or more and 12.0% by mass or less, and even more preferably 3.0% by mass or more and 10% by mass or less, with respect to the total amount of the ink composition. When the content of glycerin is in the above range, the ejection stability of the ink composition is further improved, and the occurrence of secondary curl of the recorded material is also reduced.

### 1.2.1.5. Surfactant

The ink composition used in the recording method according to the present embodiment may contain a surfactant. Examples of the surfactant include acetylene glycol-based surfactants, silicone-based surfactants, and fluorine-based surfactants. Among these, it is preferable to include an acetylene glycol-based surfactant. The ink composition contains the acetylene glycol-based surfactant, and thus the ejection stability of the ink composition is improved. Furthermore, the ink composition contains the acetylene glycol-based surfactant, so that the wetting and spreading property of the ink composition on the recording medium is improved. In addition, compared to other surfactants, the ink composition has less foaming, and the initial filling property of the ink jet printer cartridge is improved.

The acetylene glycol-based surfactant is as described in the section of “1.1.2.3. Acetylene Glycol-Based Surfactant”.

The content of the acetylene glycol-based surfactant is preferably 0.05% by mass or more and 5.0% by mass or less, more preferably 0.1% by mass or more and 4.0% by mass or less, even more preferably 0.2% by mass or more and 3.0% by mass or less, still more preferably 0.3% by mass or more and 2.0% by mass or less, and particularly preferably 0.4% by mass or more and 1.0% by mass or less, with respect to the total amount of the ink composition.

When the content of the acetylene glycol-based surfactant is in the above range, the acetylene glycol-based surfactant is less likely to phase-separate, and the ejection stability of the ink composition is further improved.

### 1.2.1.6. Water

The ink composition used in the recording method according to the present embodiment is an aqueous ink, and preferably contains water. “Aqueous” means that at least water is contained as a solvent component, and water may be contained as a main solvent component. Examples of the water include pure water such as ion-exchanged water, ultrafiltration water, reverse osmosis water, and distilled water, water having reduced ionic impurities such as ultrapure water, and the like. Furthermore, when water sterilized by irradiation with ultraviolet rays, addition of hydrogen peroxide, or the like is used, generation of bacteria and fungi can be suppressed when the ink composition is stored for a long period of time.

The content of water is preferably 30% by mass or more, more preferably 40% by mass or more, even more preferably 45% by mass or more, and particularly preferably 50% by mass or more, with respect to the total amount of the ink composition. In addition, the content of water is preferably 99% by mass or less, more preferably 90% by mass or less, and even more preferably 80% by mass or less.

### 1.2.1.7. Other Components

The ink composition used in the recording method according to the present embodiment may further contain components such as a preservative/antifungal agent, a rust preventive, a chelating agent, a viscosity modifier, and an antioxidant, as necessary.

### 1.3. Recording Medium

The recording medium used in the recording method according to the present embodiment is an absorptive recording medium. The absorptive recording medium is not particularly limited, and examples thereof include plain paper such as electrophotographic paper having high permeability of the ink composition, ink jet paper, art paper, coated paper, cast paper, or cloth having relatively low permeability of the ink composition, which are used for general offset printing, or the like. The ink jet paper is not particularly limited, and specifically, examples thereof include paper having an ink absorption layer made of silica particles or alumina particles, or an ink absorption layer made of a hydrophilic polymer such as polyvinyl alcohol (PVA) or polyvinylpyrrolidone (PVP). As the absorptive recording medium, plain paper is preferable.

The absorptive recording medium refers to the “recording medium in which the amount of water absorbed from the start of contact to 30 msec^{1/2} is more than 10 mL/m² in the Bristow method”. The Bristow method is the most popular method as a method of measuring a liquid absorption amount in a short time, and is also adopted by the Japan Technical Association of the Pulp and Paper Industry (JAPAN TAPPI). Details of a test method are described in “Paper and Paperboard-Liquid-Absorptivity Test Method-Bristow Method” of Standard No. 51 of “JAPAN TAPPI Paper and Pulp Test Method 2000 Edition”.

By adhering the treatment liquid to the absorptive recording medium in the recording method according to the present embodiment, the penetration of the ink composition into the recording medium can be reduced, and the color development property of the recorded material is improved.

### 2. Treatment Liquid Ink Set

A treatment liquid ink set according to an embodiment of the present disclosure includes the above-described treatment liquid and the above-described ink composition.

The treatment liquid ink set includes the above-described treatment liquid and the above-described ink composition, and thus the penetration of the ink composition into the recording medium at the time of recording is reduced, and a recorded material having better color development can be obtained.

The treatment liquid ink set may be any as long as the treatment liquid and the ink composition are used in a set at the time of recording, and is not limited to a case of being manufactured, sold, or the like in an integrated state. When it is assumed that the treatment liquid and the ink composition are used in combination, or when it is substantially induced to be used in combination, the treatment liquid and the ink composition are included in the set.

### 3. Recording Apparatus

A recording apparatus according to an embodiment of the present disclosure is used in the above-described recording method, and includes the above-described treatment liquid, the above-described ink composition, an ink jet head that performs a treatment liquid adhering step, and the ink jet head that performs an ink adhering step.

According to the recording apparatus according to the present embodiment, the above-described recording method can be performed, and a recorded material having the favorable color development property can be obtained.

An example of a recording apparatus that can perform the recording method according to the present embodiment will be described.

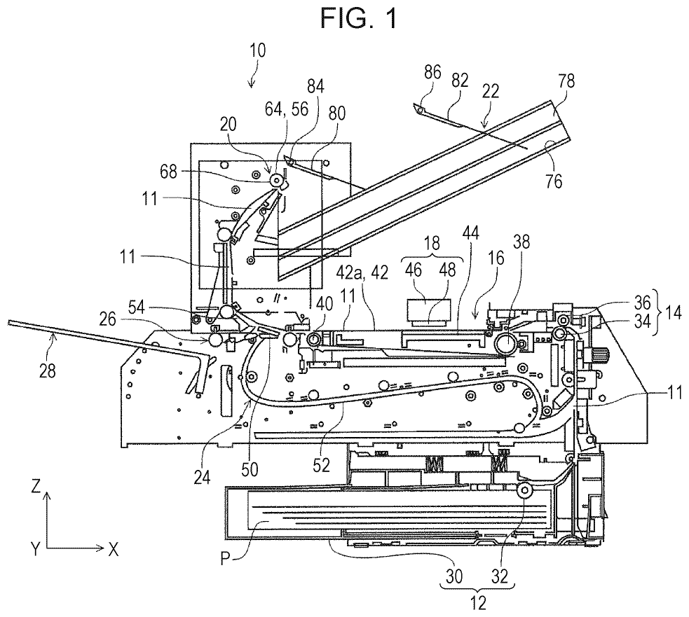

FIG. 1 is a schematic diagram of the recording apparatus. In FIG. 1, an X-Y-Z coordinate system indicates that an X direction is a length direction of a recording medium, a Y direction is a width direction of the recording medium in a transport path in the ink jet recording apparatus, and a Z direction is a height direction of the apparatus.

A recording apparatus 10 illustrated in FIG. 1 is a line-type ink jet printer (also referred to as a “line printer”) that can perform high-speed and high-density printing. As illustrated in FIG. 1, the recording apparatus 10 includes a feeding section 12 that stores a recording medium P such as paper, a transport section 14, a belt transport section 16, a recording section 18, a face-down (Fd) discharge section 20 as a “discharge section”, an Fd mounting section 22 as a “mounting section”, a reverse path section 24 as a “reverse transport mechanism”, a face-up (Fu) discharge section 26, and a Fu mounting section 28.

The feeding section 12 is disposed at the lower portion of the apparatus in the recording apparatus 10. The feeding section 12 includes a feeding tray 30 that stores the recording medium P and a feeding roller 32 that feeds the recording medium P stored in the feeding tray 30 to a transport path 11.

The recording medium P stored in the feeding tray 30 is fed to the transport section 14 along the transport path 11 by the feeding roller 32. The transport section 14 includes a transport driving roller 34 and a transport driven roller 36. A transport driving roller 34 is rotationally driven by a driving source (not illustrated in the drawing). In the transport section 14, the recording medium P is transported to the belt transport section 16 positioned downstream of the transport path 11 by being nipped between the transport driving roller 34 and the transport driven roller 36.

The belt transport section 16 includes a first roller 38 positioned upstream of the transport path 11, a second roller 40 positioned downstream, an endless belt 42 that is rotatably and movably adhered to the first roller 38 and the second roller 40, and a support 44 that supports an upper section 42a of the endless belt 42 between the first roller 38 and the second roller 40.

The endless belt 42 is driven to move in the −X direction from the +X direction in the upper section 42a by the first roller 38 or the second roller 40 driven by a driving source (not illustrated in the drawing). Therefore, the recording medium P transported from the transport section 14 is further transported to the downstream of the transport path 11 in the belt transport section 16.

The recording section 18 includes a line-type ink jet head 48 and a head holder 46 that holds the ink jet head 48. It is noted that the recording section 18 may be a serial type recording section in which an ink jet head is provided on a carriage that reciprocates in the Y axis direction. The ink jet head 48 is disposed to face the upper section 42a of the endless belt 42 supported by the support 44. The ink jet head 48 ejects the ink or the like toward the recording medium P when the recording medium P is transported in the upper section 42a of the endless belt 42, thereby carrying out recording. The recording medium P is transported by the belt transport section 16 to the downstream of the transport path 11 while the recording is carried out.

A plurality of ink jet heads 48 may be provided, and for example, the ink jet head 48 may include an ink jet head that adheres ink and an ink jet head that adheres a treatment liquid.

Here, the “line-type ink jet head” is a head used in a recording apparatus in which a region of nozzles formed in a direction intersecting a transport direction of a recording medium P is provided to cover an entire intersecting direction of the recording medium P, and in which one of the head and the recording medium P is fixed and the other is moved to form an image. The region of the nozzles in the intersecting direction of the line heads may not cover the entire intersecting direction of all the recording media P supported by the recording apparatus.

Further, a first branch section 50 is provided on the downstream of the belt transport section 16 in the transport path 11. The first branch section 50 is configured to be switchable between the transport path 11 for transporting the recording medium P to the Fd discharge section 20 or the Fu discharge section 26, and a reversing path 52 of the reverse path section 24 for reversing the recording surface of the recording medium P and transporting again the recording medium P to the recording section 18. It is noted that the recording medium P that is transported by being switched to the reversing path 52 by the first branch section 50 has a recording surface that is reversed in the transport process in the reversing path 52, and the recording medium is transported again to the recording section 18 such that the surface opposite to the initial recording surface faces the ink jet head 48.

Further, a second branch section 54 is provided on the downstream of the first branch section 50 along the transport path 11. The second branch section 54 is configured to be able to switch the transport direction of the recording medium P so that the recording medium P is transported toward the Fd discharge section 20 or the recording medium P is transported toward the Fu discharge section 26.

The recording medium P transported toward the Fd discharge section 20 in the second branch section 54 is discharged from the Fd discharge section 20 and mounted on the Fd mounting section 22. In this case, the recording surface of the recording medium P is mounted to face the Fd mounting section 22. In addition, the recording medium P transported toward the Fu discharge section 26 in the second branch section 54 is discharged from the Fu discharge section 26 and mounted on the Fu mounting section 28. In this case, the recording surface of the recording medium P is mounted to face the side opposite to the Fu mounting section 28.

The recording apparatus according to the present embodiment may perform scanning in which the relative positions of the ink jet head that performs the treatment liquid adhering step and the ink jet head that performs the ink adhering step and the recording medium are moved, to adhere the treatment liquid and the ink composition. In addition, the ink jet head that performs the treatment liquid adhering step and the ink jet head that performs the ink adhering step are line heads having a length equal to or longer than a recording width in a direction intersecting a scanning direction of the recording medium, and may perform recording by performing one scanning.

The line printer has a high recording speed and immediately transports the recording medium to which the ink is adhered to the paper discharge tray to be stacked in large numbers. Therefore, when the recording medium curls after the ink adheres, the line printer may not be able to transport the recording medium well and may cause a paper jam. In addition, when the cut paper is used for the recording medium, when the curl occurs, it becomes difficult to stack the cut paper on the paper discharge tray. In the recording method according to the present embodiment, the primary curl and the secondary curl are reduced by adhering the treatment liquid of the present embodiment to the recording medium, and thus the method is effective and particularly useful in the case of a line printer.

Although an example of a case where a line-type ink jet head is used is described, the recording apparatus according to the present embodiment may be a serial printer using a serial-type ink jet head. When a serial printer is used, the printing is performed by moving the ink jet head in a direction intersecting the transport direction while transporting the recording medium in the transport direction. Even when the serial printer is used, when recording is performed on the absorptive recording medium, the problem of the color development property of the recorded material occurs. Therefore, by using the above-described recording method, an effect of improving the color development property of the recorded material can be obtained.

### 4. Examples

Hereinafter, the present disclosure will be described in more detail with reference to examples, but the present disclosure is not limited to these examples. Hereinafter, “%” is based on mass unless otherwise specified.

### 4.1. Preparation of Ink Composition

The ink composition used in each of Examples and Comparative Examples is obtained by the following procedure.

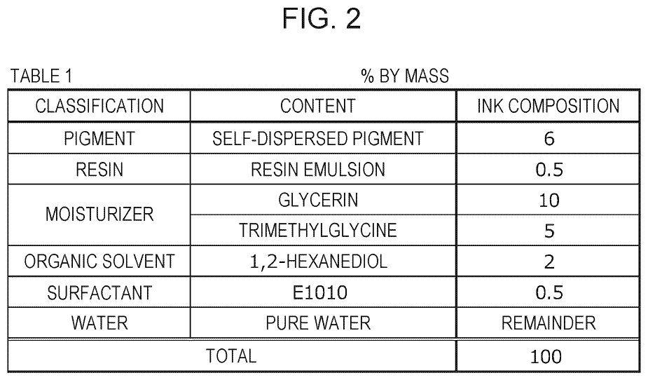

FIG. 2 (Table 1) is a table showing the composition of the ink composition. Each component was put into a container so as to have the composition shown in Table 1, and after mixing and stirring for 2 hours with a magnetic stirrer, the ink composition used in each example and each comparative example was obtained by filtering with a membrane filter having a pore size of 5 μm. The numerical values of the respective components in the table represent % by mass.

The abbreviations and other product names used in Table 1 will be supplemented.

### Pigment

Self-dispersed pigment: Trade name “CAB-O-JET300”, manufactured by cabot corporation, solid content 15%

### Resin

Resin emulsion: A styrene-acrylic resin emulsion is prepared using a styrene monomer and an acrylic monomer. Tg is 10° C. and the acid value is 33 mgKOH/g.

### Surfactant

E1010: Trade name “Olefin E1010”, manufactured by Nisshin Chemical Industry Co., Ltd., acetylene glycol-based surfactant

### 4.2. Preparation of Treatment Liquid

The treatment liquid used in each example and each comparative example is obtained by the following procedure.

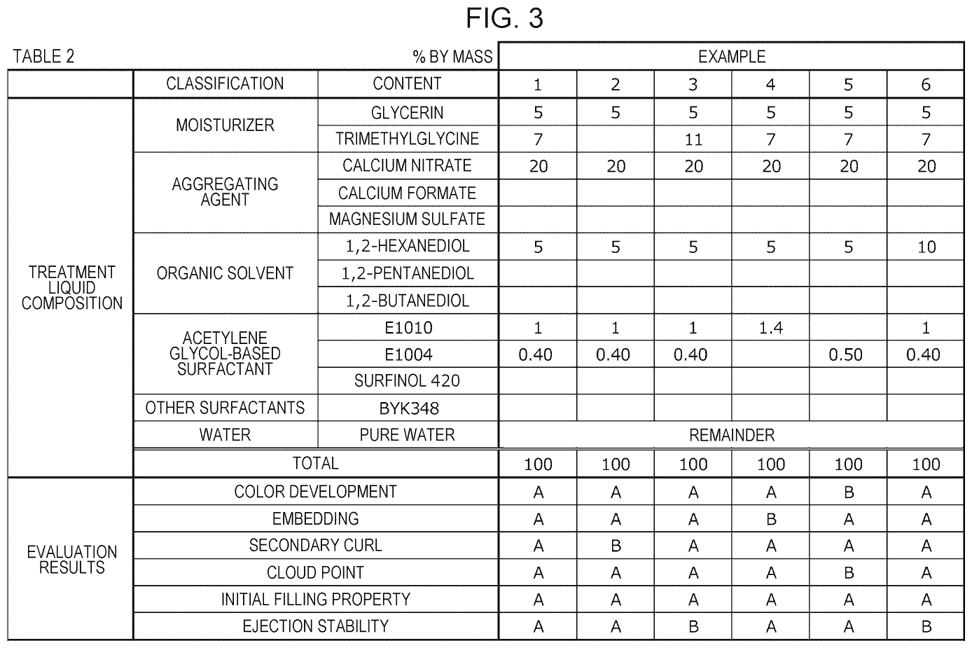

FIG. 3 (Table 2) is a table showing the composition of the treatment liquid. In the same manner as in the section of “4.1. Preparation of Ink Composition”, each component was put into a container so as to have the composition shown in Table 2, and then mixed and stirred for 2 hours with a magnetic stirrer, and then filtered with a membrane filter having a pore size of 5 μm to obtain a treatment liquid used in each of Examples and Comparative Examples. The numerical values in the table represent % by mass.

The abbreviations and other trade names used in Table 2 will be supplemented.

### Aggregating Agent

Calcium nitrate: Water solubility at 20° C.=121.2 g/100 g water

Calcium formate: Water solubility at 20° C.=16.6 g/100 g water

Moisturizer

Trimethylglycine: Betaine

### Organic Solvent

1,2-hexanediol: Surface tension at 25° C.=26.4 mN/m
1,2-pentanediol: Surface tension at 25° C.=27.7 mN/m
1,2-butanediol: Surface tension at 25° C.=31.6 mN/m

The surface tension is measured by the Wilhelmy method in an environment of 25° C. using a surface tension meter (manufactured by Kyowa Interface Science Co., Ltd., surface tension meter CBVP-Z).

### Surfactant

E1010: Trade name “Olefin E1010”, manufactured by Nisshin Chemical Industry Co., Ltd., acetylene glycol-based surfactant, HLB value 13 to 14

E1004: Trade name “Orfin E1004”41, manufactured by Nisshin Chemical Industry Co., Ltd., acetylene glycol-based surfactant HLB 7 to 9

Surfynol 420: Trade name “Surfynol 420”, manufactured by Nisshin Chemical Industry Co., Ltd., acetylene glycol-based surfactant, HLB value 4

BYK-348: Trade name manufactured by BYK Chemie Japan Co., Ltd., silicone-based surfactant

### 4.3. Evaluation Method

### 4.3.1. Recording Conditions

A model obtained by modifying LX-10050 (manufactured by Seiko Epson Corporation, line printer) is used as the recording apparatus. In the above-described recording apparatus, the recording time resolution is set to 600×2400 dpi, and the injection amount of treatment liquid or the like is set to 4.5 mg/inch² at Duty 100%.

As the recording medium, A4 size business plain paper (manufactured by Seiko Epson Corporation, copy paper) (hereinafter, also referred to as “business plain paper”) or A4 size Xerox P paper (manufactured by Fuji Xerox Co., Ltd., copy paper, basis weight 64 g/m², paper thickness 88 μm) (hereinafter, also referred to as “thick paper”) is used.

### 4.3.2. Color Development Property

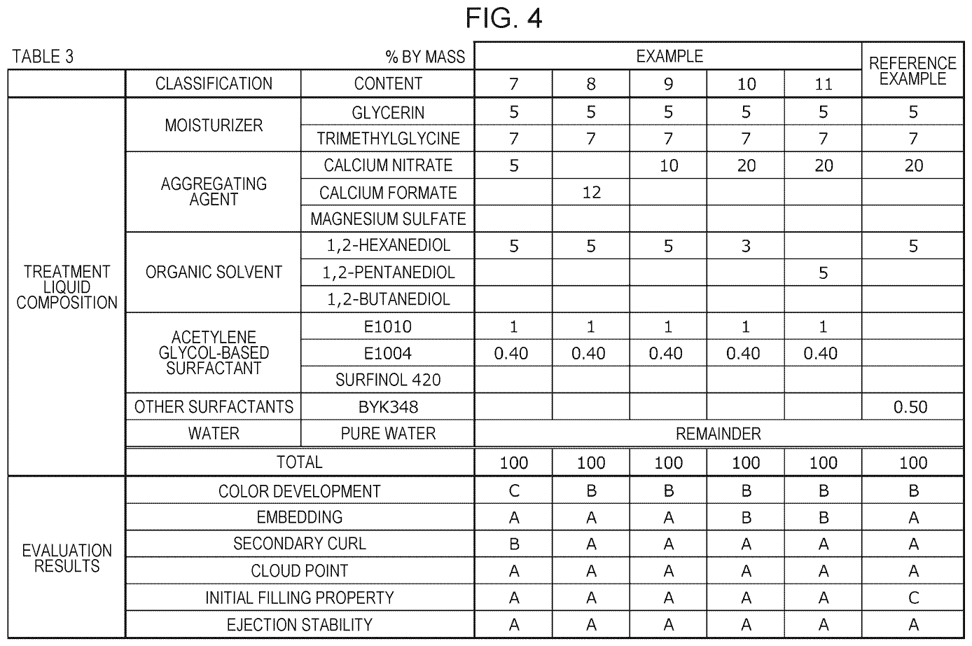

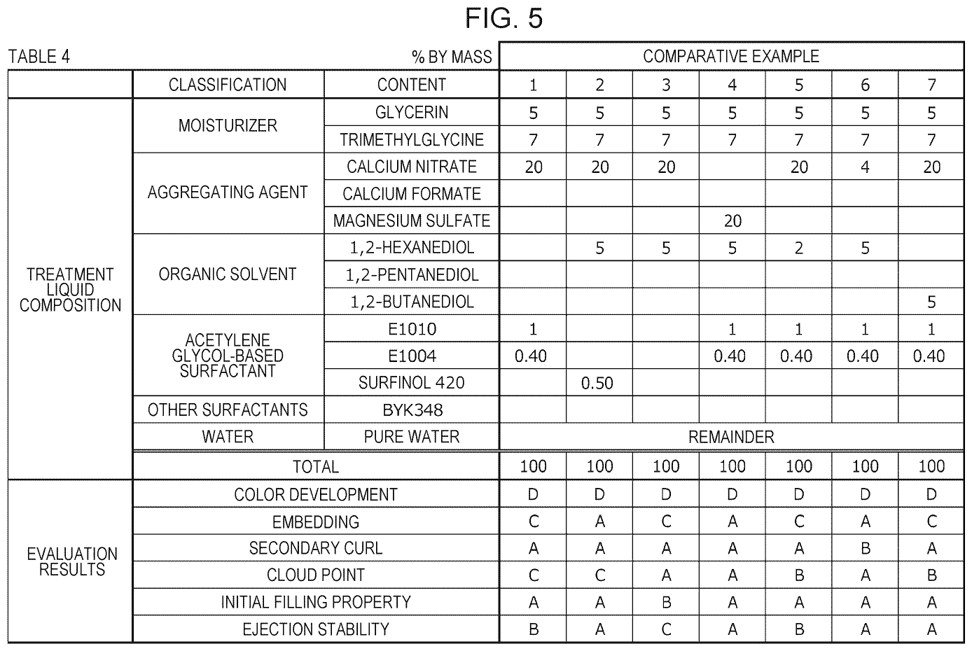

A recording apparatus is filled with a treatment liquid, and a solid pattern of Duty 100% is printed on a business plain paper. Thereafter, the recording apparatus is filled with the ink composition, and printing is performed on the business plain paper to which the treatment liquid is adhered to obtain a recorded material. The optical density (OD value) of the obtained recorded material is measured using a fluorescence spectrophotometer (“FD-7”, manufactured by Konica Minolta, Inc.). The evaluation criteria are as follows, and the results are shown in FIGS. 3 to 5 (Tables 2to 4).

### Evaluation Criteria

A: OD value is 1.53 or more

B: OD value is 1.49 or more and less than 1.53

C: OD value is 1.45 or more and less than 1.49

D: OD value is less than 1.45

### 4.3.3. Embedding of Treatment Liquid

A recording apparatus is filled with a treatment liquid to which 5% of the dye is added, and a solid pattern is printed such that the resolution is 600×1200 dpi, the Duty is 50%, and the injection amount is 2.25 mg/inch². The recording medium uses business plain paper. The dye is a water-soluble blue dye. The obtained recorded material is observed with a microscope, and the coating area of the treatment liquid is evaluated. The evaluation criteria are as follows, and the results are shown in Tables 2 to 4.

### Evaluation Criteria

A: Coating area of the treatment liquid is 50% or more

B: Coating area of the treatment liquid is 45% or more and less than 50%

C: Coating area of the treatment liquid is less than 45%

### 4.3.4. Secondary Curl

A recording apparatus is filled with a treatment liquid, and a solid pattern of Duty 100% is printed on a thick paper under an environment of a temperature of 25° C. and a humidity of 50%. Thereafter, the recording apparatus is filled with the ink composition, and a solid pattern of Duty 100% is printed on the thick paper to which the treatment liquid is adhered to obtain a recorded material. The obtained recorded material is placed with the printing surface up, left for one week, and then the amount (hereinafter, also referred to as “floating amount”) by which the end portion of the recorded material is floated from the floor surface is measured. The evaluation criteria are as follows, and the results are shown in Tables 2 to 4.

### Evaluation Criteria

A: The floating amount is less than 10 mm

B: The floating amount is 10 mm or more and less than 20 mm

C: The floating amount is 20 mm or more

### 4.3.5. Cloud Point

Each of the treatment liquids of the examples and comparative examples prepared in the section of “4.2. Preparation of Treatment Liquid” is sealed in a 100 mL bottle and left to stand in a constant temperature bath at 60° C. for 24 hours. After 24 hours have passed, the state of the treatment liquid is visually checked. The evaluation criteria are as follows, and the results are shown in FIGS. 3 to 5 (Tables 2 to 4).

### Evaluation Criteria

A: There is no oil separation

B: Slightly cloudy

C: There is oil separation

### 4.3.6. Initial Filling Property

A cartridge for the treatment liquid is filled in the recording apparatus, and when the initial filling is performed in the recording apparatus, a nozzle check pattern after the initial filling sequence is printed. When there is missing print or wrinkle in the nozzle check pattern of the recorded material, the nozzle check pattern is further printed by a manual operation. The number of times until the nozzle check pattern is not checked for the missing print or wrinkle, that is, until all the nozzles can eject ink is measured. The missing print means a non-ejection part confirmed by printing the nozzle check pattern, and the wrinkle means a part where the flight bending of the droplet occurs, which is confirmed by printing the nozzle check pattern. The evaluation criteria are as follows, and the results are shown in Tables 2 to 4.

### Evaluation Criteria

A: All the nozzles can eject ink only by the initial filling sequence

B: The initial filling sequence and all the nozzles can be ejected within 3 manual operations

C: The initial filling sequence and all the nozzles cannot be ejected unless more than 3 manual operations are performed

### 4.3.7. Ejection Stability

The cartridge is mounted on the recording apparatus, and is filled with the treatment liquid. It is confirmed that the treatment liquid is ejected from the plurality of nozzles communicating with the cartridge filled with the treatment liquid, and a test pattern is continuously printed on 30 sheets of business plain paper. After printing 30 sheets, a nozzle check is performed to confirm the ejection state of the nozzles. The evaluation criteria are as follows, and the results are shown in Tables 2 to 4. The wrinkle is a landing position shift of half or more of the inter-nozzle distance.

### Evaluation Criteria

A: There is no nozzle slipping or wrinkle.

B: There are 5 or less nozzle slippings or wrinkles, and recovery is achieved by performing head cleaning once.

C: There are 10 or less nozzles slippings or wrinkles, and recovery is achieved by performing head cleaning two or more times.

### 4.4. Evaluation Results

In the examples relating to the recording method including the treatment liquid adhering step of ejecting the treatment liquid containing the aggregating agent from the ink jet head to adhere the treatment liquid to a recording medium, and the ink adhering step of ejecting the ink composition which is the aqueous ink containing the coloring material from the ink jet head to adhere the ink composition to the recording medium, in which the recording medium is the absorptive recording medium, the treatment liquid contains a 1,2-alkanediol having a surface tension at 25° C. of 30 mN/m or less and an acetylene glycol-based surfactant having an HLB value of 5 or more, a content of the 1,2-alkanediol is 3% by mass or more with respect to a total amount of the treatment liquid, the aggregating agent contains a calcium salt, and a content of the calcium salt is 5% by mass or more with respect to the total amount of the treatment liquid, all examples show favorable results in the color development property evaluation item. Furthermore, there is a tendency that the embedding, the secondary curl suppression, the water solubility, the initial filling property, and the ejection stability are also excellent.

On the other hand, the comparative examples that do not satisfy the above conditions do not obtain favorable results in the color development property evaluation item.

In the comparison between Example 1 and Comparative Examples 1, 5, and 7, it is shown that when the treatment liquid contains 1,2-alkanediol having the surface tension at 25° C. of 30 mN/m or less, the color development property of the recorded material is improved. The embedding of the treatment liquid during recording is also favorable. In addition, in the evaluation item of the cloud point, the oil separation of the treatment liquid does not occur. Furthermore, when the content of the above-described 1,2-alkanediol is 3% by mass or more with respect to the total amount of the treatment liquid, the color development property of the recorded material becomes more favorable.

In the comparison between Example 1 and Comparative Examples 2 and 3, it is shown that the color development property of the recorded material is improved by containing the acetylene glycol-based surfactant in the treatment liquid. In addition, the ejection stability during recording is also improved, and the embedding of the treatment liquid is also favorable. Furthermore, since the HLB value of the acetylene glycol-based surfactant contained is 5 or more, the oil separation of the treatment liquid does not occur.

In the comparison between Example 1 and Comparative Examples 4 and 6, it is shown that when the treatment liquid contains the aggregating agent and the aggregating agent is a calcium salt, the color development property of the recorded material is improved. In addition, when the content of the calcium salt is 5% by mass or more with respect to the total amount of the treatment liquid, the color development property of the recorded material is more favorable.

From Examples 1 to 3, the treatment liquid containing betaine tends to reduce the occurrence of secondary curl of the recorded material. In addition, when the content of betaine is in a predetermined range with respect to the total amount of the treatment liquid, the ejection stability at the time of recording is improved.

From Examples 1, 4, and 5, when the acetylene glycol-based surfactant contained in the treatment liquid contains an acetylene glycol-based surfactant having an HLB value of 10 or more, the color development property and water solubility are excellent, and when the acetylene glycol-based surfactant contained in the treatment liquid contains an acetylene glycol-based surfactant having an HLB value of 5 or more and less than 10, the embedding of the treatment liquid is more excellent. The composition preferably contains an acetylene glycol-based surfactant having an HLB value of 10 or more and an acetylene glycol-based surfactant having an HLB value of 5 or more and less than 10.

From Examples 6 and 10, when the content of 1,2-alkanediol having a surface tension at 25° C. of 30 mN/m or less in the treatment liquid is within a predetermined range with respect to the total amount of the treatment liquid, the ejection stability during recording is improved, the embedding of the treatment liquid in the recording medium is more favorable, and the color development property of the recorded material is improved.

From Examples 7 and 9, when the content of the calcium salt contained in the treatment liquid is in a predetermined range with respect to the total amount of the treatment liquid, the color development property of the recorded material is further improved. In addition, the secondary curl suppression is more excellent.

From Example 8, when the calcium salt contained in the treatment liquid is an inorganic calcium salt, the color development property of the recorded material is further improved.

From Example 11, regardless of the type of 1,2-alkanediol having a surface tension at 25° C. of 30 mN/m or less, the recorded material shows favorable color development by being contained in the treatment liquid.

The present disclosure is not limited to the above-described embodiment, and various modifications are possible. For example, the present disclosure includes a configuration substantially the same as the configuration described in the embodiment, for example, a configuration having the same function, method, and result, or a configuration having the same object and effect. Further, the present disclosure includes a configuration in which a non-essential part of the configuration described in the embodiment is replaced. In addition, the present disclosure includes a configuration that achieves the same action effects as the configuration described in the embodiment or a configuration that can achieve the same object. Further, the present disclosure includes a configuration in which a known technique is added to the configuration described in the embodiment.

The following contents are derived from the above-described embodiments and modification examples.

A recording method according to an aspect includes
a treatment liquid adhering step of ejecting a treatment liquid containing an aggregating agent from an ink jet head to adhere the treatment liquid to a recording medium, and
an ink adhering step of ejecting an ink composition which is an aqueous ink containing a coloring material from the ink jet head to adhere the ink composition to the recording medium, in which
the recording medium is an absorptive recording medium,
the treatment liquid contains a 1,2-alkanediol having a surface tension at 25° C. of 30 mN/m or less and an acetylene glycol-based surfactant having an HLB value of 5 or more,
a content of the 1,2-alkanediol is 3% by mass or more with respect to a total amount of the treatment liquid, the aggregating agent contains a calcium salt, and
a content of the calcium salt is 5% by mass or more with respect to the total amount of the treatment liquid.

According to this recording method, the embedding of the treatment liquid in the recording medium is favorable, the penetration of the ink composition adhered by the treatment liquid is suppressed, and the color development property of the recorded material is improved. In addition, the initial filling property to the recording apparatus is also favorable, and the ejection stability at the time of recording is also improved.

In the above recording method, the treatment liquid may contain betaine, and a content of the betaine may be 2% by mass or more and 10% by mass or less with respect to the total amount of the treatment liquid.

According to this recording method, the occurrence of the secondary curl of the recorded material is reduced.

In the above recording method, the content of the calcium salt may be 8% by mass or more and 25% by mass or less with respect to the total amount of the treatment liquid.

According to this recording method, the coloring material or the like in the ink composition is suitably aggregated, and the color development of the recorded material is improved.

In the above recording method, the content of the 1,2-alkanediol may be 3% by mass or more and 9% by mass or less with respect to the total amount of the treatment liquid.

According to this recording method, the ejection stability at the time of recording is improved. In addition, the embedding of the treatment liquid in the recording medium is favorable, and thus, the color development property of the recorded material is improved.

In the above recording method, the acetylene glycol-based surfactant may include an acetylene glycol-based surfactant having an HLB value of 10 or more and an acetylene glycol-based surfactant having an HLB value of 5 or more and less than 10.

According to this recording method, the embedding of the treatment liquid in the recording medium is favorable, and the color development property of the recorded material is also favorable.

In the recording method described above, the recording medium may be plain paper.

According to this recording method, even when the material is a material that is easily penetrated by the ink composition, the penetration of the ink composition is reduced by the treatment liquid, and a recorded material having favorable color development can be obtained.

In the above recording method, the calcium salt may be an inorganic calcium salt.

According to this recording method, the color development property of the recorded material is improved.

A treatment liquid ink set according to an aspect is used in the above-described recording method, and the treatment liquid ink set includes the treatment liquid and the ink composition.

According to the treatment liquid ink set, a recorded material having favorable color development property can be obtained.

A recording apparatus according to an aspect is used in the above-described recording method, and the recording apparatus includes
the treatment liquid,
the ink composition,
an ink jet head that performs the treatment liquid adhering step, and
an ink jet head that performs the ink adhering step.

According to the recording apparatus, the above-described recording method can be suitably performed, and a recorded material having favorable color development property can be obtained.

In the above recording apparatus,
the adhering of the treatment liquid and the ink composition may be performed by scanning performed while moving relative positions of the ink jet head that performs the treatment liquid adhering step and the ink jet head that performs the ink adhering step and the recording medium,
the ink jet head that performs the treatment liquid adhering step and the ink jet head that performs the ink adhering step may be line heads having a length equal to or more than a recording width of the recording medium in a direction intersecting a direction of the scanning, and
recording may be performed by performing the scanning once.

According to this recording apparatus, a recorded material having favorable color development property can be obtained.

What is claimed is:

1. A recording method comprising:
a treatment liquid adhering step of ejecting a treatment liquid containing an aggregating agent from an ink jet head to adhere the treatment liquid to a recording medium; and
an ink adhering step of ejecting an ink composition which is an aqueous ink containing a coloring material from the ink jet head to adhere the ink composition to the recording medium, wherein
the recording medium is an absorptive recording medium,
the treatment liquid contains a 1,2-alkanediol having a surface tension at 25° C of 30 mN/m or less and an acetylene glycol-based surfactant having an HLB value of 5 or more,
a content of the 1,2-alkanediol is 3% by mass or more with respect to a total amount of the treatment liquid,
the aggregating agent contains a calcium salt, and
a content of the calcium salt is 5% by mass or more with respect to the total amount of the treatment liquid.

2. The recording method according to claim 1, wherein
the treatment liquid contains betaine, and
a content of the betaine is 2% by mass or more and 10% by mass or less with respect to the total amount of the treatment liquid.

3. The recording method according to claim 1, wherein
the content of the calcium salt is 8% by mass or more and 25% by mass or less with respect to the total amount of the treatment liquid.

4. The recording method according to claim 1, wherein
the content of the 1,2-alkanediol is 3% by mass or more and 9% by mass or less with respect to the total amount of the treatment liquid.

5. The recording method according to claim 1, wherein
the acetylene glycol-based surfactant includes an acetylene glycol-based surfactant having an HLB value of 10 or more and an acetylene glycol-based surfactant having an HLB value of 5 or more and less than 10.

6. The recording method according to claim 1, wherein the recording medium is plain paper.

7. The recording method according to claim 1, wherein the calcium salt is an inorganic calcium salt.

8. A treatment liquid ink set used in the recording method according to claim 1, the treatment liquid ink set comprising: the treatment liquid and the ink composition.

9. A recording apparatus used in the recording method according to claim 1, the recording apparatus comprising:
the treatment liquid;
the ink composition;
the ink jet head that performs the treatment liquid adhering step; and
the ink jet head that performs the ink adhering step.

10. The recording apparatus according to claim 9, wherein
the adhering of the treatment liquid and the ink composition is performed by scanning performed while moving relative positions of the ink jet head that performs the treatment liquid adhering step and the ink jet head that performs the ink adhering step and the recording medium,
the ink jet head that performs the treatment liquid adhering step and the ink jet head that performs the ink adhering step are line heads having a length equal to or more than a recording width of the recording medium in a direction intersecting a direction of the scanning, and
recording is performed by performing the scanning once.
